(19) United States
(12) Patent Application Publication
(10) Pub. No.: US 2024/0082731 A1
(43) Pub. Date: Mar. 14, 2024

(54) STORAGE MEDIUM, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Yuya SATO, Kyoto (JP); Takashi KUBOKI, Tokyo (JP)

(21) Appl. No.: 18/240,772

(22) Filed: Aug. 31, 2023

(30) Foreign Application Priority Data
Sep. 12, 2022 (JP) 2022-144906

(51) Int. Cl. A63F 13/58; A63F 13/44; A63F 13/56

(52) U.S. Cl. CPC A63F 13/58; A63F 13/44; A63F 13/56

(57) ABSTRACT

An example of an information processing system moves a player character in accordance with an operation of a player, automatically moves a first non-player character, and if the player character comes close to the first non-player character, in accordance with an operation input provided by the player, causes the player character to transition to an implementable state where the player character can implement a first effect associated with the first non-player character. If the player character is in the implementable state, in accordance with an operation input provided by the player, the example of the information processing system causes the player character to perform a predetermined action and also implement the first effect.

### CROSS REFERENCE TO RELATED APPLICATION

This application claims priority to Japanese Patent Application No. 2022-144906 filed on Sep. 12, 2022, the entire contents of which are incorporated herein by reference.

### FIELD

An exemplary embodiment relates to a non-transitory computer-readable storage medium having stored therein a game program, an information processing system, an information processing apparatus, and an information processing method that are capable of performing a game using a player character and a non-player character.

### BACKGROUND AND SUMMARY

Conventionally, there is a game where a player character and a non-player character cooperate to battle. Specifically, in the conventional game, a player character and a plurality of non-player characters are present, and in the state where the player character and a non-player character are paired together, the paired characters caused to make a support attack in accordance with an instruction given by a player.

However, there is room for improvement in implementing an effect related to a non-player character at a desired position or timing while automatically controlling the non-player character.

Therefore, it is an object of an exemplary embodiment to provide a non-transitory computer-readable storage medium having stored therein a game program, an information processing system, an information processing apparatus, and an information processing method that are capable of implementing an effect associated with a non-player character at a desired position or timing in a game where a player character is operated.

To achieve the above object, the exemplary embodiment employs the following configurations.

(First Configuration)

Instructions according to a first configuration, when executed, cause a computer of an information processing apparatus to execute game processing including moving a player character in a virtual space based on a first operation input. The game processing also includes automatically moving a first non-player character in the virtual space, if the player character and the first non-player character have a predetermined positional relationship, in accordance with a second operation input, causing the player character to transition to an implementable state where the player character can implement a predetermined action having a first effect, and if the player character is in the implementable state, in accordance with a third operation input, causing the player character to perform the predetermined action having the first effect.

Based on the above, it is possible to cause a player character to transition to an implementable state using a first non-player character, and cause the player character to perform a predetermined action having a first effect in accordance with a third operation input in the implementable state. Consequently, it is possible to implement the first effect using the first non-player character and implement the first effect at a desired position or timing.

(Second Configuration)

According to a second configuration, in the above first configuration, the game processing may further include, if the player character is caused to perform the predetermined action having the first effect, causing the player character to transition from the implementable state to a non-implementable state where the player character cannot implement the predetermined action having the first effect.

Based on the above, if the predetermined action having the first effect is performed, the player character is caused to transition to a non-implementable state. To bring the player character into the implementable state, it is necessary to move the player character so that the player character and the first non-player character have a predetermined positional relationship every time. Thus, it is possible to urge the use of the first non-player character.

(Third Configuration)

According to a third configuration, in the above second configuration, the game processing may further include: controlling an enemy character in the virtual space; causing the enemy character to perform an attack action; causing damage on the player character based on the attack action of the enemy character; and if the player character is in the implementable state, disabling or reducing the damage based on the attack action of the enemy character.

Based on the above, it is possible to further disable or reduce damage on the player character in the implementable state. It is possible to further provide the advantage of causing the player character to transition to the implementable state. Thus, it is possible to urge the use of the first non-player character.

(Fourth Configuration)

According to a fourth configuration, in the above third configuration, the game processing may further include, if the damage is disabled or reduced, causing the player character to transition from the implementable state to the non-implementable state.

Based on the above, the player character is caused to transition to the implementable state once, whereby it is possible to produce either of the effect of implementing the first effect with the predetermined action and the effect of disabling or reducing damage due to the attack of an enemy character. If the player character is attacked by an enemy character, the player character enters the non-implementable state and cannot implement the first effect with the predetermined action, but damage due to the attack of the enemy character is disabled or reduced. Thus, this is advantage for a player. The player character enters the non-implementable state in accordance with the attack of the enemy character. Thus, it is possible to prevent the player from having an excessive advantage and maintain the balance of the game.

(Fifth Configuration)

According to a fifth configuration, in any of the above second to fourth configurations, the game processing may further include maintaining the player character in the non-implementable state until a predetermined time elapses after the player character transitions from the implementable state to the non-implementable state.

Based on the above, if the player character transitions from the implementable state to the non-implementable state, the non-implementable state is maintained until a predetermined time elapses. Thus, it is possible to prevent the player character from continuously transitioning to the implementable state in a short time.

(Sixth Configuration)

According to a sixth configuration, in any of the above first to fifth configurations, the game processing may further include causing the player character to perform an attack action as the predetermined action based on the third operation input, regardless of whether or not the player character is in the implementable state. The first effect may be an additional attack effect produced with the attack action.

Based on the above, it is possible to implement the first effect in addition to a normal attack action. This is excellent in operability for a player. Thus, it is possible to make it easy to implement the first effect by taking aim in the implementable state.

(Seventh Configuration)

According to a seventh configuration, in the above sixth configuration, the game processing may further include equipping the player character with any of a plurality of types of weapon objects. The attack action may be an action of making an attack using the weapon object with which the player character is equipped, and the additional attack effect may have a performance that differs in accordance with the type of the weapon object with which the player character is equipped.

Based on the above, it is possible to implement an attack effect having a performance that differs depending on the type of a weapon object. The player can select a desired weapon object in the implementable state and implement the first effect in accordance with the third operation input.

(Eighth Configuration)

According to an eighth configuration, in the above sixth or seventh configuration, the attack effect may have an effect of removing a predetermined obstacle object in the virtual space.

Based on the above, it is possible to further remove an obstacle object. The player can remove an obstacle object by taking aim in the implementable state.

(Ninth Configuration)

According to a ninth configuration, in any of the above first to eighth configurations, the game processing may further include: automatically moving a second non-player character in the virtual space; and if the player character and the second non-player character have a predetermined positional relationship, producing a second effect in accordance with the second operation input.

Based on the above, a second operation input is provided by bringing the player character into a predetermined positional relationship with a second non-player character, whereby it is possible to produce a second effect. Regarding the first non-player character, in a case where the player character and the first non-player character have a predetermined positional relationship, and if the second operation input is provided, the player character transitions to the implementable state. Thus, even if the player character transitions to the implementable state against a player's intention, the first effect is not immediately implemented, and it is possible to prevent an effect against the player's intention from being produced.

(Tenth Configuration)

According to a tenth configuration, in the above ninth configuration, the game processing may further include causing the first non-player character and the second non-player character to automatically battle.

Based on the above, the first non-player character and the second non-player character automatically battle. This is advantageous for the player.

Another exemplary embodiment may be an information processing system that executes the above game processing, or may be an information processing apparatus, or may be an information processing method executed by an information processing system.

According to the exemplary embodiment, it is possible to cause a player character to transition to an implementable state and then implement a first effect. Thus, it is possible to implement the first effect related to a first non-player character at a desired position or timing.

These and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an exemplary state where a left controller 3 and a right controller 4 are attached to a main body apparatus 2;

FIG. 2 is an example non-limiting block diagram showing an exemplary internal configuration of the main body apparatus 2;

FIG. 3 is an example non-limiting six-sided view showing the left controller 3;

FIG. 4 is an example non-limiting six-sided view showing the right controller 4;

FIG. 5 is an example non-limiting diagram showing an example of a game image displayed on a display 12 or a stationary monitor in a case where a game according to an exemplary embodiment is executed;

FIG. 6 is an example non-limiting diagram showing an example of a game image displayed when a player character 100 comes close to a first NPC 110;

FIG. 7 is an example non-limiting diagram showing an example of a game image displayed when the player character 100 enters the state where the player character 100 can implement a predetermined action having a first effect associated with the first NPC 110;

FIG. 8 is an example non-limiting diagram showing an example of a game image displayed when the player character 100 is attacked by an enemy character 200 in a case where the player character 100 is in an implementable state;

FIG. 9 is an example non-limiting diagram showing an example of a game image displayed after the player character 100 is attacked by the enemy character 200 in a case where the player character 100 is in the implementable state;

FIG. 10 is an example non-limiting diagram showing an example of a game image displayed before the player character 100 performs an attack action using a sword object 101 in the implementable state;

FIG. 11 is an example non-limiting diagram showing an example of a game image displayed after the player character 100 performs the attack action using the sword object 101 in the implementable state;

FIG. 12 is an example non-limiting diagram showing an example of a game image before the player character 100 performs an attack action using a sword object 102 in the implementable state;

FIG. 13 is an example non-limiting diagram showing an example of a game image displayed after the player character 100 performs the attack action using the sword object 102 in the implementable state;

FIG. 14 is an example non-limiting diagram showing an example of a game image displayed in the state where another object placed in a virtual space is removed using a water object 105;

FIG. 15 is an example non-limiting diagram showing an example of a game image displayed when the other object is removed in a case where the water object 105 hits the other object;

FIG. 16 is an example non-limiting diagram showing an example of data stored in a memory of the main body apparatus 2 during the execution of game processing;

FIG. 17 is an example non-limiting flow chart showing an example of game processing executed by a processor 81 of the main body apparatus 2;

FIG. 18 is an example non-limiting flow chart showing an example of a state transition process in step S105;

FIG. 19 is an example non-limiting flow chart showing an example of a player character attack action process in step S106; and

FIG. 20 is an example non-limiting flow chart showing an example of a player character damage process in step S107.

### DETAILED DESCRIPTION OF NON-LIMITING EXAMPLE EMBODIMENTS

(System Configuration)

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. Hereinafter, first, the hardware configuration of the game system 1 according to the exemplary embodiment is described, and then, the control of the game system 1 according to the exemplary embodiment is described.

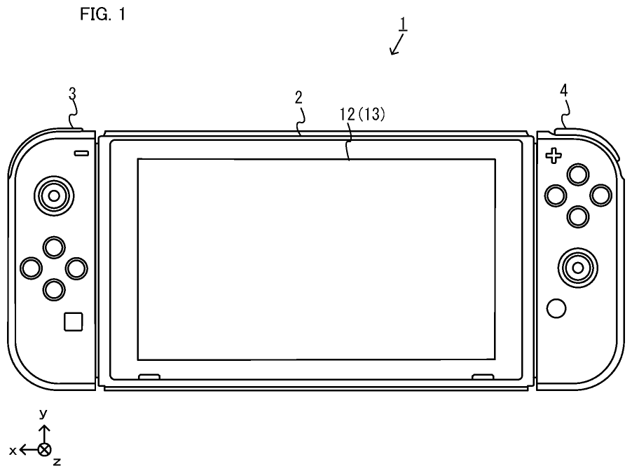

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

The left controller 3 and the right controller 4 are attachable to and detachable from the main body apparatus 2. It should be noted that hereinafter, the left controller 3 and the right controller 4 will occasionally be referred to collectively as a “controller”.

The main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus. The main body apparatus 2 or the unified apparatus may function as a portable apparatus.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

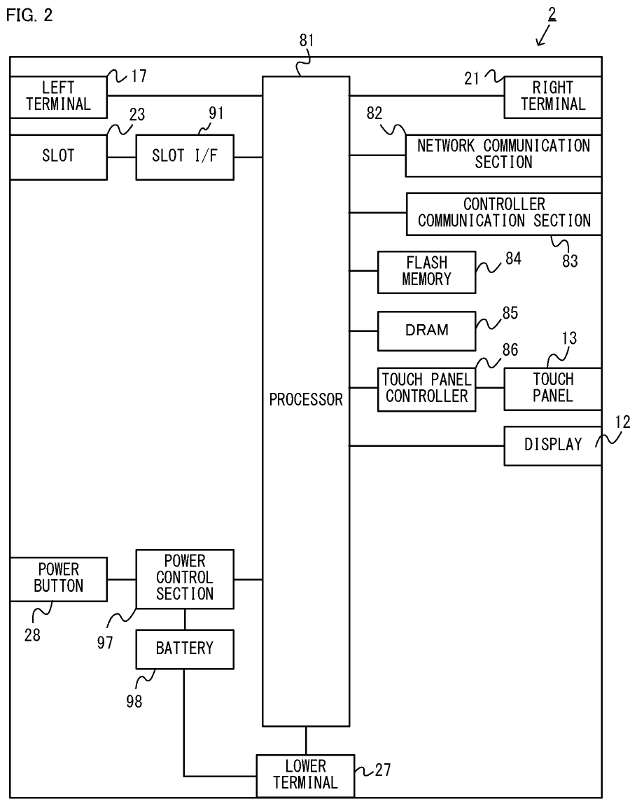

FIG. 2 is a block diagram showing an example of the internal configuration of the main body apparatus 2.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of an SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication).

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates, for example, data indicating the position where a touch input is provided. Then, the touch panel controller 86 outputs the data to the processor 81.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

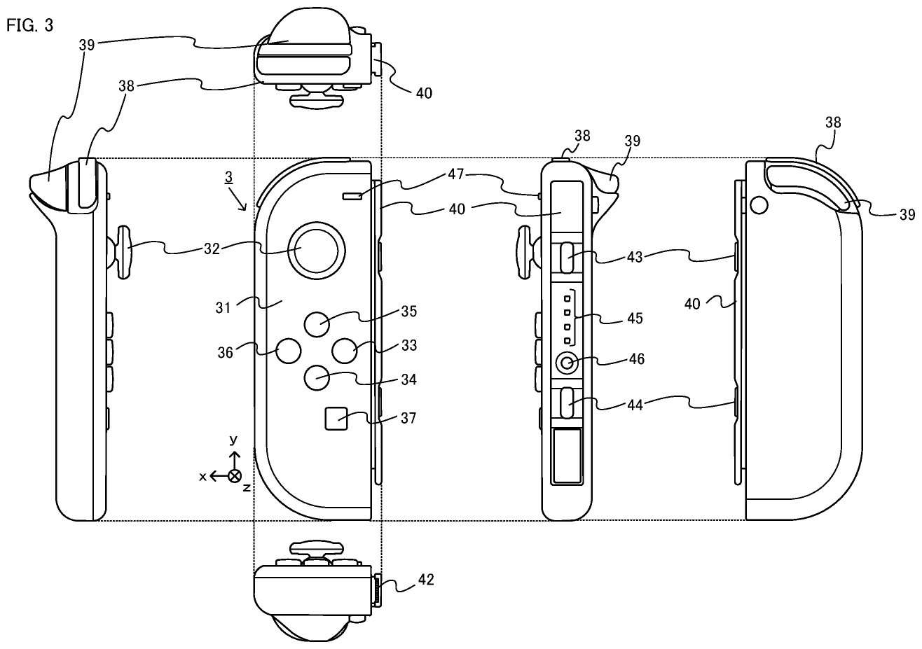

FIG. 3 is six orthogonal views showing an example of the left controller 3. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 3, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

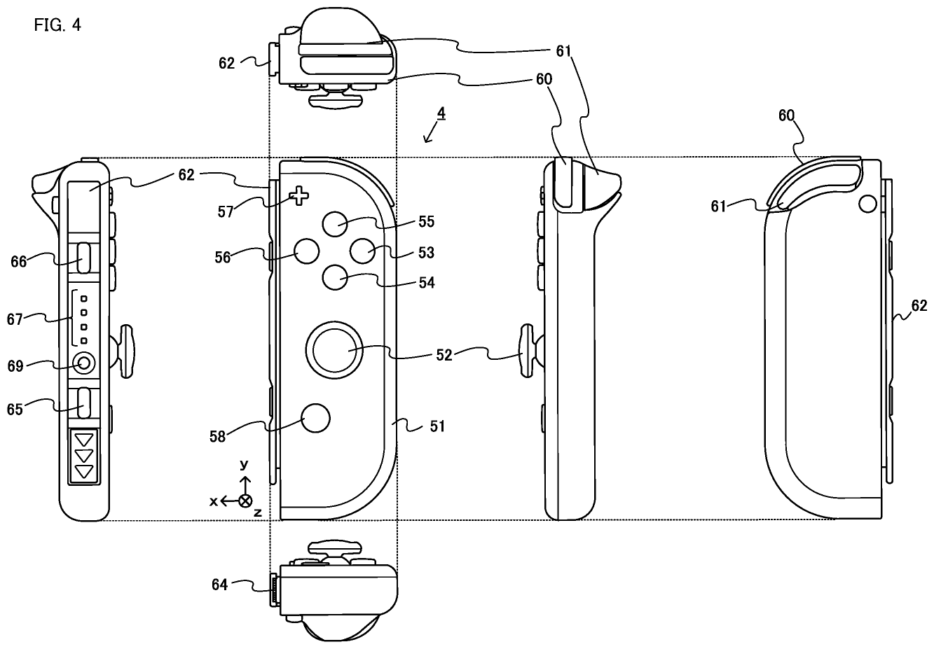

FIG. 4 is six orthogonal views showing an example of the right controller 4. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

(Overview of Game)

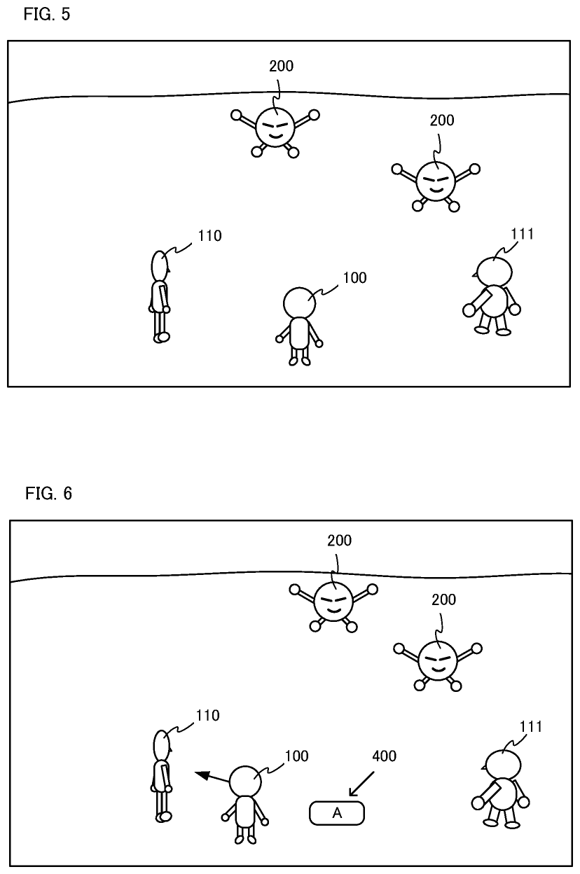

Next, a game according to the exemplary embodiment is described. FIG. 5 is a diagram showing an example of a game image displayed on the display 12 or the stationary monitor in a case where the game according to the exemplary embodiment is executed.

As shown in FIG. 5, a player character 100 and enemy characters 200 are placed in a three-dimensional virtual space (game space). The player character 100 is a character operated by a player, and for example, moves in the virtual space in accordance with an operation on the left analog stick 32. The enemy characters 200 are automatically controlled by the processor 81.

In accordance with an instruction given by the player, the player character 100 performs an attack action. Specifically, the player character 100 can acquire and own a plurality of weapon objects during the progress of the game. The player selects any of the plurality of weapon objects owned by the player character 100 and equips the player character 100 with the weapon object. In accordance with an operation input provided by the player, the player character 100 performs an attack action using the weapon object with which the player character 100 is equipped.

In the game according to the exemplary embodiment, the weapon objects include sword objects, a spear object, an axe object, and the like used basically in the state where the player character 100 holds each object. The attack action of the player character 100 differs depending on the weapon object with which the player character 100 is equipped. For example, in a case where the player character 100 is equipped with a sword object, and if an operation input for an attack is provided, the player character 100 performs an attack action of swinging the sword object. In a case where the player character 100 is equipped with the spear object, and if an operation input for an attack is provided, the player character 100 performs an attack action of thrusting the spear object. The weapon objects also include a bow-and-arrow object that the player character 100 can discharge to the virtual space. Each of the plurality of weapon objects has a different offensive strength in advance. If an attack action is performed using a weapon object having a great offensive strength, and the attack action hits an enemy character 200, great damage is caused on the enemy character 200.

The player character 100 moves in the virtual space while defeating the plurality of enemy characters 200. The player character 100 has a life value, and if the player character 100 is attacked by an enemy character 200, the life value decreases. If the life value of the player character 100 reaches zero, the game is over. For example, the player character 100 returns to a saved point, and the game is resumed.

As shown in FIG. 5, a first non-player character (NPC) 110 and a second non-player character (NPC) 111 are placed in the virtual space. The first NPC 110 and the second NPC 111 are company characters of the player character 100 and are automatically controlled by the processor 81. If the player character 100 moves in the virtual space, the first NPC 110 and the second NPC 111 move by following the player character 100. For example, the first NPC 110 and the second NPC 111 automatically move in the virtual space so as not to separate by a predetermined distance or more from the player character 100. The first NPC 110 and the second NPC 111 also assist the player character 100. For example, the first NPC 110 and the second NPC 111 automatically fight with an enemy character 200 and defeat the enemy character 200.

Each of the first NPC 110 and the second NPC 111 is associated with a unique effect. If the player character 100 comes close to the first NPC 110 or the second NPC 111, the player character 100 becomes able to implement the effect associated with the first NPC 110 or the second NPC 111.

FIG. 6 is a diagram showing an example of a game image displayed when the player character 100 comes close to the first NPC 110. For example, the first NPC 110 and the second NPC 111 automatically move in accordance with the movement of the player character 100. If the player character 100 stops, the first NPC 110 and the second NPC 111 also stop. In this state, the player moves the player character 100 toward the first NPC 110 using the left analog stick 32. As shown in FIG. 6, if the player character 100 comes close to the first NPC 110 (if the distance between the player character 100 and the first NPC 110 becomes less than or equal to a predetermined value), for example, a button image 400 that urges the pressing of the A-button is displayed. At this time, if the player presses the A-button, the player character 100 enters the state where the player character 100 can implement a predetermined action having a first effect associated with the first NPC 110. For example, the first NPC 110 is a character having a water attribute, and the first effect associated with the first NPC 110 is an effect related to water.

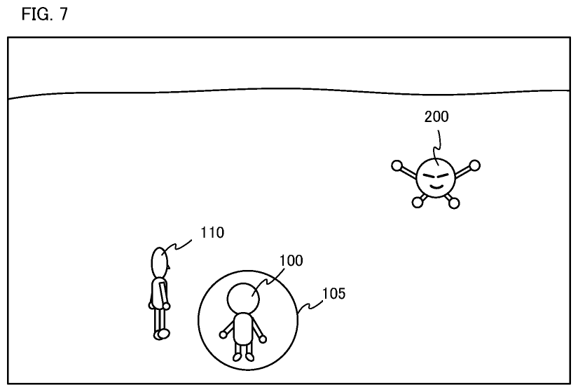

FIG. 7 is a diagram showing an example of a game image displayed when the player character 100 enters the state where the player character 100 can implement the predetermined action having the first effect associated with the first NPC 110. As shown in FIG. 7, if the player character 100 comes close to the first NPC 110 and the A-button is pressed, the player character 100 enters the state where the player character 100 wears a water object 105 (the state where the player character 100 is surrounded by the water object 105). Here, this state is occasionally referred to as an “implementable state”. For example, the water object 105 is a translucent object representing water. The player character 100 can move in the virtual space, change its direction, and perform an attack action in this state.

The implementable state continues for a predetermined effective period (e.g., 10 seconds). If the predetermined effective period elapses after the player character 100 enters the implementable state, the player character 100 returns to a normal state (a non-implementable state).

In the implementable state, the player character 100 can defend from the attack of an enemy character 200 only once.

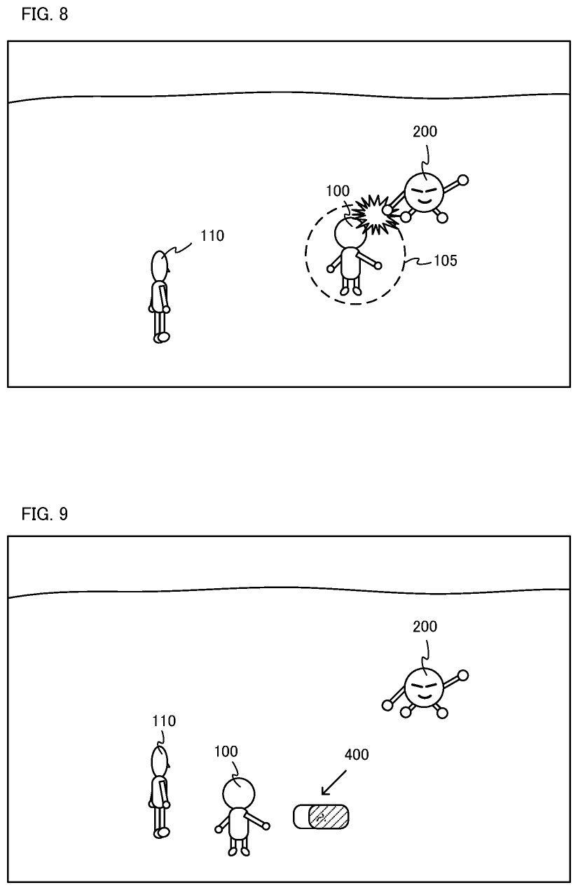

FIG. 8 is a diagram showing an example of a game image displayed when the player character 100 is attacked by an enemy character 200 in a case where the player character 100 is in the implementable state. FIG. 9 is a diagram showing an example of a game image displayed after the player character 100 is attacked by the enemy character 200 in a case where the player character 100 is in the implementable state.

As shown in FIG. 8, if the player character 100 is attacked by an enemy character 200 in the implementable state, the attack of the enemy character 200 is disabled (or reduced), and the player character 100 does not become damaged (or damage on the player character 100 is reduced). That is, even if the attack of the enemy character 200 hits the player character 100 (or the water object 105), the life value of the player character 100 does not decrease (or the amount of decrease in the life value decreases). Then, if the attack of the enemy character 200 is disabled or reduced, the water object 105 is erased even before the above predetermined effective period elapses. Then, the player character 100 transitions from the implementable state to the non-implementable state. If the player character 100 transitions from the implementable state to the non-implementable state, the player character 100 does not transition to the implementable state again until a predetermined restriction period elapses. For example, as shown in FIG. 9, during the predetermined restriction period, if the player character 100 moves close to the first NPC 110, the button image 400 changes to a display form indicating that the pressing of the A-button is not enabled. Specifically, a gauge is displayed in the button image 400, and the gauge extends in accordance with the lapse of time. If the predetermined restriction period elapses, the gauge of the button image 400 extends to the end, and the player character 100 becomes able to transition to the implementable state again (the pressing of the A-button becomes enabled).

For example, the predetermined restriction period may be the period from when the attack of the enemy character 200 is disabled or reduced to when a certain time (e.g., 10 seconds) elapses. Alternatively, the predetermined restriction period may be the period from when the player character 100 transitions to the implementable state to when a certain time (e.g., 10 seconds) elapses. In this case, if the above predetermined effective period elapses after the player character 100 enters the implementable state, the player character 100 returns to the normal state (the non-implementable state), but the predetermined restriction period has elapsed at this time, and the player character 100 may be able to immediately transition to the implementable state. If, on the other hand, for example, the player character 100 is attacked by an enemy character 200 and disables or reduces the attack by the time when the above predetermined effective period elapses after the player character 100 enters the implementable state, the predetermined restriction period has not yet elapsed, and the player character 100 cannot immediately transition to the implementable state.

As described above, in the game according to the exemplary embodiment, if the player character 100 is in the implementable state, and even if the attack of an enemy character 200 hits the player character 100, the player character 100 can disable or reduce the attack.

In the exemplary embodiment, the life value of the player character 100 may be decreased for a reason other than the attack of an enemy character 200. For example, there is a high-temperature environment in the virtual space, and if the player character 100 is in the high-temperature environment, the life value of the player character 100 is decreased. For example, there is a lava in a volcano scene, and if the player character 100 comes close to the lava, the life value of the player character 100 decreases. Moreover, there is a place where flame spews out, and if the player character 100 hits the flame, the life value of the player character 100 decreases. Even in a case where the player character 100 is in such a high-temperature environment, but if the player character 100 is in the implementable state, the life value of the player character 100 does not decrease (or the amount of decrease in the life value decreases). That is, since the water object 105 has the water attribute, the player character 100 is protected from the high-temperature environment, and does not become damaged (or damage on the player character 100 is reduced) in the state where the player character 100 wears the water object 105. Even in a case where the player character 100 is not in the implementable state, but if the player character 100 has a predetermined item having the water attribute, the player character 100 may be able to reduce damage from such a high-temperature environment, or may not become damaged using the item.

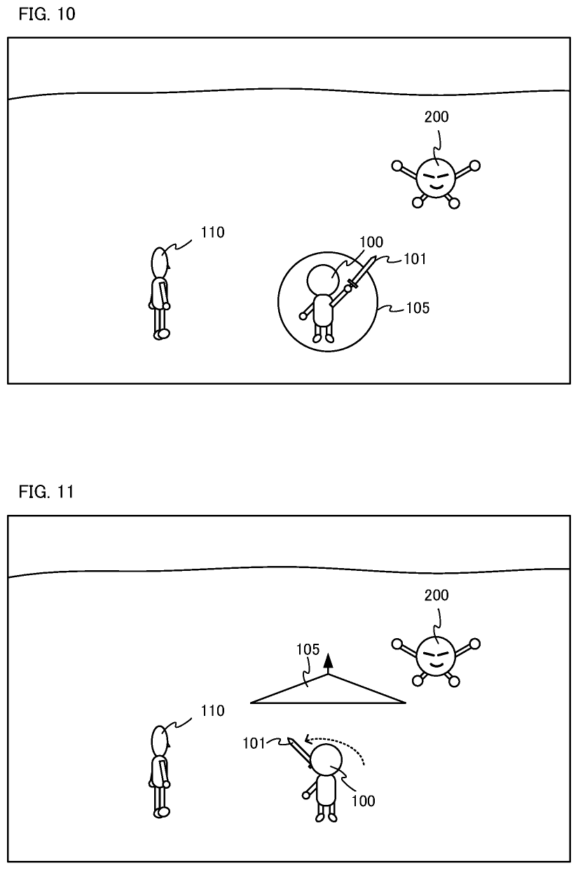

Next, a case is described where the player character 100 performs an attack action in the implementable state. FIG. 10 is a diagram showing an example of a game image displayed before the player character 100 performs an attack action using a sword object 101 in the implementable state. FIG. 11 is a diagram showing an example of a game image displayed after the player character 100 performs the attack action using the sword object 101 in the implementable state.

As shown in FIG. 10, if a sword object 101 is selected as a weapon object with which the player character 100 is equipped by the player, the player character 100 enters the state where the player character 100 is equipped with the sword object 101 (the state where the player character 100 uses the sword object 101). If an operation input for an attack action (e.g., the pressing of the Y-button 56) is provided in this state, as shown in FIG. 11, the player character 100 performs an attack action of swinging the sword object 101, and the water object 105 is discharged to the virtual space. The water object 105 is an object having the properties of water and has an attack effect on an enemy character 200. The discharged water object 105 moves in the virtual space by a predetermined distance and disappears. If the water object 105 hits an enemy character 200, damage is caused on the enemy character 200.

If the water object 105 is discharged to the virtual space, the player character 100 transitions from the implementable state to the non-implementable state. If the player character 100 transitions from the implementable state to the non-implementable state, the player character 100 does not transition to the implementable state again until the predetermined restriction period elapses. The predetermined restriction period may be the period from when the water object 105 is discharged to when a certain time (e.g., 10 seconds) elapses. Alternatively, the predetermined restriction period may be the period from when the player character 100 transitions to the implementable state to when a certain time elapses.

The direction in which the water object 105 is discharged is set in accordance with the direction of the player character 100. Specifically, the direction in which the water object 105 is discharged is a direction along the ground where the player character 100 is, and is the front direction of the player character 100. The player can control the direction of the player character 100 and control the discharge direction of the water object 105 using the left analog stick 32.

As described above, if the player character 100 is in the implementable state, and the player character 100 performs the attack action of swinging the sword object 101, the water object 105, which is an additional attack effect, is discharged with the attack action to the virtual space. Consequently, the player character 100 can attack the enemy character 200 using the water object 105.

Here, the performances, such as the shape, the size (the width), the moving velocity, the flying distance, and the offensive strength, of the water object 105 that is discharged to the virtual space differ depending on the weapon object used for the attack action.

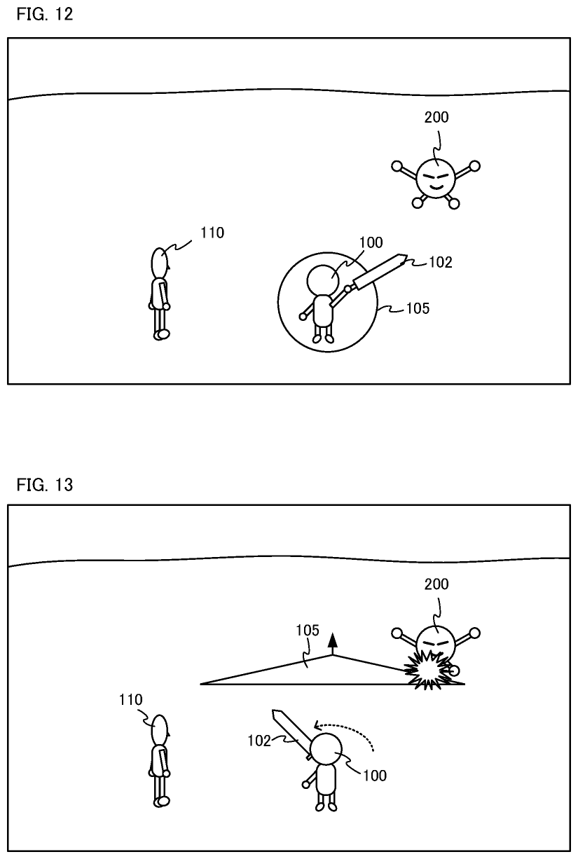

FIG. 12 is a diagram showing an example of a game image displayed before the player character 100 performs an attack action using a sword object 102 in the implementable state. FIG. 13 is a diagram showing an example of a game image displayed after the player character 100 performs the attack action using the sword object 102 in the implementable state.

Even if the player character 100 is in the implementable state, the player can select any of the plurality of weapon objects and equip the player character 100 with the selected weapon object. As shown in FIG. 12, for example, if a sword object 102 is selected as a weapon object, the player character 100 enters the state where the player character 100 is equipped with the sword object 102. If an operation input for an attack (e.g., the pressing of the Y-button 56) is provided in this state, as shown in FIG. 13, the player character 100 performs an attack action of swinging the sword object 102, and the water object 105 is discharged to the virtual space.

As is clear from the comparison between FIGS. 11 and 13, the water object 105 discharged when the attack action is performed using the sword object 102 is larger (has a wider width) than the water object 105 discharged when the attack action is performed using the sword object 101. Thus, even if the positional relationship between the discharge direction of the water object 105 and the enemy character 200 is the same, the water object 105 does not hit the enemy character 200 if the attack action is performed using the sword object 101, but the water object 105 hits the enemy character 200 if the attack action is performed using the sword object 102. If the water object 105 hits the enemy character 200, the enemy character 200 becomes damaged. If the damage on the enemy character 200 exceeds a threshold (the life value of the enemy character 200 reaches zero), the enemy character 200 falls over.

The flying distance of the water object 105 also differs between when the attack action is performed using the sword object 102 and when the attack action is performed using the sword object 101. For example, when the attack action is performed using the sword object 102, the flying distance of the water object 105 may be shorter than when the attack action is performed using the sword object 101. The moving velocity of the water object 105 also differs between when the attack action is performed using the sword object 102 and when the attack action is performed using the sword object 101. For example, when the attack action is performed using the sword object 102, the moving velocity of the water object 105 may be slower than when the attack action is performed using the sword object 101.

If the water object 105 hits the enemy character 200, the water object 105 may not disappear (may not stop) at this time, and may move further in the discharge direction, advance to a flying distance set in advance, and disappear. In this case, the player character 100 can attack not only the enemy character 200 hit by the water object 105, but also an enemy character further in the discharge direction than the hit enemy character. If the water object 105 hits the enemy character 200, the water object 105 may disappear at the time.

The water object 105 has a predetermined offensive strength. The offensive strength of the water object 105 differs depending on the offensive strength of the weapon object that is used. For example, “3” is set in advance as the offensive strength of the sword object 101, and “5” is set in advance as the offensive strength of the sword object 102. In this case, the offensive strength of the water object 105 in a case where the attack action is performed using the sword object 101 is “3”. The offensive strength of the water object 105 in a case where the attack action is performed using the sword object 102 is “5”. Thus, in a case where the sword object 102 is used, damage on the enemy character 200 when the water object 105 hits the enemy character 200 is greater than that in a case where the sword object 101 is used.

If the distance between the player character 100 and the enemy character 200 is close, the water object 105 discharged by the attack action using the sword object 101 or 102 may hit the enemy character 200, and the sword object 101 or 102 may also hit the enemy character 200. In this case, damage due to the hitting of the water object 105 and damage due to the hitting of the sword object 101 or 102 may be caused on the enemy character 200. In another exemplary embodiment, in this case, only damage due to the water object 105 may be caused on the enemy character 200.

Although not shown in the figures, the size, the flying distance, the moving velocity, and the offensive strength of the water object 105 discharged when the attack action is performed differ between a case where the player character 100 is equipped with the spear object and a case where the player character 100 is equipped with the sword object 101 or 102. For example, in a case where the player character 100 performs the attack action using the spear object in the implementable state, the width of the water object 105 is narrower, the moving velocity of the water object 105 is faster, and the flying distance of the water object 105 is longer than in a case where the player character 100 performs the attack action using the sword object 101 or 102. Thus, if the spear object is selected, the player character 100 can attack an enemy character 200 further away from the player character 100.

The enemy characters 200 include enemy characters having different attributes. For example, the enemy characters 200 include an enemy character having a fire attribute and an enemy character having an attribute other than the fire attribute. If the water object 105 hits an enemy character having the fire attribute, damage greater than that when the water object 105 hits an enemy character that does not have the fire attribute can be caused on the enemy character having the fire attribute. For example, the player character 100 may not be able to defeat an enemy character that does not have the fire attribute without hitting the enemy character with the water object 105 multiple times, but may be able to defeat an enemy character having the fire attribute by hitting the enemy character with the water object 105 only once.

As described above, if the player character 100 performs a predetermined attack action in the implementable state, the player character 100 can discharge the water object 105 to the virtual space, and can attack an enemy character 200 using the water object 105. The shape, the size, the flying distance, the moving velocity, the offensive strength, and the like of the water object 105 differ depending on the type of the weapon object with which the player character 100 is equipped. Thus, in accordance with the player's preference or the situation of the enemy character 200, the player can appropriately use a weapon object with which the player character 100 is equipped, and make an attack using the water object 105. The water object 105 has the water attribute, and the enemy characters 200 also have various attributes. Thus, the player can perform the game by determining whether or not to make an attack using the water object 105, depending on the attribute of the enemy character 200.

Here, the water object 105 can be used not only in a case where an enemy character 200 is attacked, but also in a case where another object placed in the virtual space is removed.

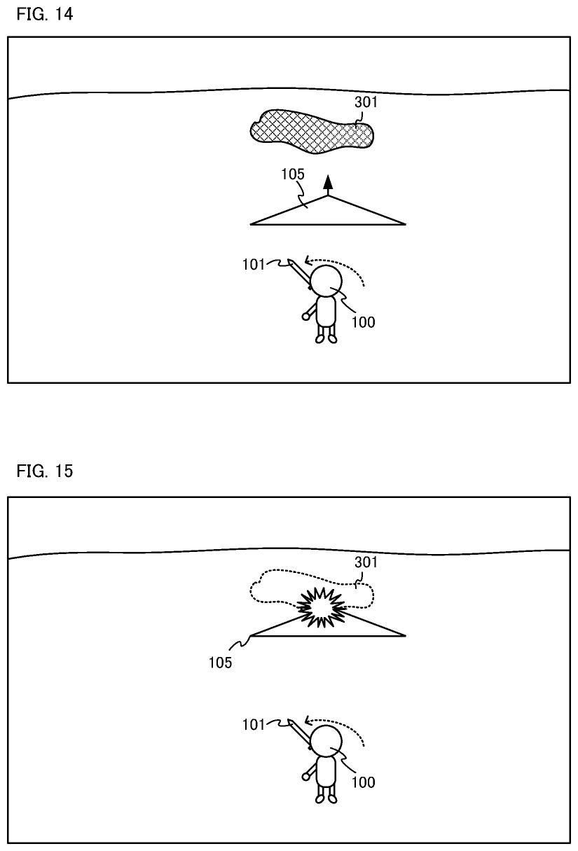

FIG. 14 is a diagram showing an example of a game image of the state where another object placed in the virtual space is removed using the water object 105. FIG. 15 is a diagram showing an example of a game image displayed when the other object is removed in a case where the water object 105 hits the other object.

As shown in FIG. 14, for example, a sludge object 301 is placed in the virtual space. The sludge object 301 is an object representing high-viscosity mud and is an obstacle object that hinders the movement of the player character 100. If the player character 100 enters the placement area of the sludge object 301, the moving velocity of the player character 100 becomes slow. The sludge object 301 is an object vulnerable to the water attribute. As shown in FIG. 15, if the water object 105 discharged to the virtual space hits the sludge object 301, the sludge object 301 is destroyed and removed.

The sludge object 301 can be removed using not only the water object 105, but also another item having the water attribute that is owned by the player character 100. For example, if another item having the water attribute is selected by the player, and the player character 100 discharges the other item to the virtual space, and the discharged other item hits the sludge object 301, the sludge object 301 is removed.

In a case where the water object 105 is discharged, and even if the water object 105 hits the sludge object 301, the water object 105 advances by the flying distance set in advance. Thus, in a case where the water object 105 is used, a plurality of sludge objects 301 in the discharge direction of the water object 105 can be removed. In contrast, in a case where another item having the water attribute is used, and if the other item hits the sludge object 301, the sludge object 301 is removed, and the other item disappears. Thus, in a case where the other item is used, a plurality of sludge objects 301 cannot be removed. In another exemplary embodiment, if the water object 105 hits the sludge object 301, the sludge object 301 may be removed, and the water object 105 may disappear at the time.

Although not shown in the figures, there is a fire object as an obstacle to the player character 100 in the virtual space. If the player character 100 hits the fire object, the player character 100 becomes damaged. The player character 100 can extinguish the fire object by hitting the fire object with the water object 105. The player character 100 can also extinguish the fire object using another item (an item having the water attribute) owned by the player character 100. There may be an object that can be extinguished (destroyed) only by the water object 105 in the virtual space.

The sword objects, the spear object, the axe object, and the like are weapon objects basically used to make an attack in the state where the player character 100 is in proximity to an enemy character 200. Here, such weapon objects basically used to make an attack in the state where the player character 100 is in proximity to an enemy character 200 are occasionally referred to as “proximity weapon objects”. As described above, if the player character 100 performs an attack action using a proximity weapon object in the implementable state, the water object 105 is discharged. This enables a remote attack.

On the other hand, the weapon objects include a weapon object (e.g., a bow-and-arrow object) for attacking an enemy character 200 separate from the player character 100 by discharging the weapon object to the virtual space in addition to the proximity weapon objects. Such a weapon object such as the bow-and-arrow object for attacking an enemy character 200 separate from the player character 100 is occasionally referred to as a “remote weapon object”. If a remote weapon object is used, a target image is displayed on the screen, and the player takes aim using the target image. If an operation input for discharging the remote weapon object is provided, the remote weapon object is discharged toward a position in the virtual space indicated by the target image. If the discharged remote weapon object hits an enemy character 200, damage is caused on the enemy character 200, and the remote weapon object disappears.

If the player character 100 performs an attack action using a remote weapon object in the implementable state, the water object 105 is not discharged, and only the remote weapon object is discharged to the virtual space. In this case, the implementable state of the player character 100 is maintained.

When the player character 100 is equipped with a proximity weapon object in the normal state, and if a predetermined operation input is provided by the player, the player character 100 throws the proximity weapon object to the virtual space. For example, the player can specify the up-down direction and the left-right direction in the virtual space and cause the player character 100 to throw the proximity weapon object. If, on the other hand, the player character 100 is in the implementable state, and a predetermined operation input for throwing the proximity weapon object is provided, the water object 105 is discharged in a specified direction. In this case, the proximity weapon object is not thrown to the virtual space.

As described above, when the player character 100 is equipped with a proximity weapon object in the implementable state, the water object 105 is discharged. When the player character 100 is equipped with a remote weapon object, the water object 105 is not discharged. Consequently, it is possible to prevent the player from having an excessive advantage by using the remote weapon object. For example, if the remote weapon object is discharged and the water object 105 is also discharged, the player can remotely make both an attack using the remote weapon object and an attack using the water object 105 by taking aim at an enemy character 200. As a result, even though the risk of the player character 100 being attacked by the enemy character 200 is low, the player character 100 can make a powerful attack, and the player may have an excessive advantage. Thus, in the exemplary embodiment, a weapon object and the water object 105 are prohibited from being simultaneously discharged to the virtual space. In another exemplary embodiment, a weapon object and the water object 105 may be configured to be allowed to be simultaneously discharged to the virtual space. For example, if the player character 100 performs an attack action using a remote weapon object in the implementable state, the remote weapon object may be discharged toward an indicated position in the virtual space, and the water object 105 may also be discharged.

As described above, if the player character 100 comes close to the first NPC 110, and for example, the A-button is pressed, the player character 100 enters the state where the player character 100 wears the water object 105 (the state where the player character 100 can implement the first effect associated with the first NPC 110). If a proximity weapon object is selected and an attack action using the proximity weapon object is performed in this state, the water object 105 is discharged (the first effect is implemented) with the attack action. In the state where the player character 100 wears the water object 105, the attack of an enemy character 200 is disabled (or reduced), and the player character 100 does not become damaged (damage on the player character 100 is reduced).

If the player character 100 comes close to the second NPC 111, and for example, the A-button is pressed, a second effect associated with the second NPC 111 is produced. “The second effect is produced” means that an effect different from the first effect is produced, and for example, may mean that the player character 100 enters the state where the player character 100 can make a predetermined attack, or may mean that an area where the player character 100 can make a predetermined attack is set, or may mean that a predetermined area expands, or may mean that the player character 100 enters the state where the player character 100 is protected from a particular situation.

As described above, in the game according to the exemplary embodiment, when the player character 100 is near the first NPC 110, and for example, if the A-button is pressed, the player character 100 enters the state where the player character 100 can implement the first effect associated with the first NPC 110. Then, if an operation input for an attack action is provided in the implementable state, an attack action having the first effect is performed. Consequently, the player can advance the game using the attribute of the first NPC 110. When the player character 100 is in the implementable state, the first effect is implemented in accordance with an operation input for an attack action, and therefore, the player can implement the first effect at a desired timing or position. For example, when the player character 100 is in the implementable state, the player can move the player character 100 to a desired position, adjust the discharge direction, and discharge the water object 105. The player can also cause the player character 100 to transition to the implementable state and then change a weapon object with which the player character 100 is equipped. Since the size (the width), the flying distance, the moving velocity, the offensive strength, and the like of the water object differ in accordance with the type of the weapon object, the player can select the range (the width) and the distance of an attack using the water object 105 in accordance with the situation of the enemy character 200 and discharge the water object 105.

When the player character 100 is near the first NPC 110, and even if the A-button is erroneously pressed, the player character 100 is caused to transition to the implementable state, whereby it is possible to prevent the water object 105 from being erroneously discharged. The player moves the player character 100 close to the first NPC 110 and presses the A-button to bring the player character 100 into the implementable state, and therefore, it is possible to prevent the player character 100 from erroneously transitioning to the implementable state.

If the player character 100 is attacked by an enemy character 200 in the implementable state, the player character 100 transitions to the non-implementable state, but even if the player character 100 is attacked by an enemy character 200, this attack is disabled (or reduced). Thus, even if the player character 100 transitions to the non-implementable state, this is advantage for the player. Thus, it is possible to urge the player to bring the player character 100 close to the first NPC 110 and into the implementable state.

When the player character 100 is in the implementable state, and if the player character 100 is attacked by an enemy character 200 or the water object 105 is discharged, the player character 100 transitions from the implementable state to the non-implementable state. In this case, the player character 100 does not transition to the implementable state again until the predetermined restriction period elapses. Consequently, it is possible to prevent the player character 100 from continuously making an attack using the water object 105 in a short time or prevent the player character 100 from continuously being in the state where the player character 100 is protected by the water object 105. Thus, it is possible to prevent the player from having an excessive advantage.

(Description of Data Used in Game Processing)

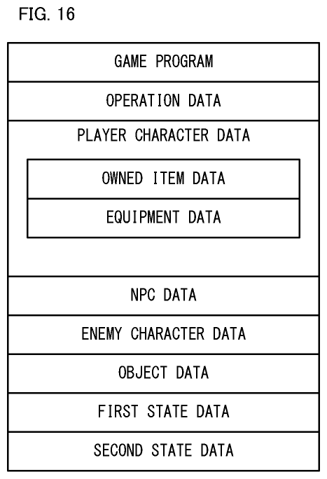

Next, the details of game processing are described. First, data used in the game processing is described. FIG. 16 is a diagram showing an example of data stored in a memory of the main body apparatus 2 during the execution of the game processing.

As shown in FIG. 16, the memory (the DRAM 85, the flash memory 84, or the external storage medium) of the main body apparatus 2 stores a game program, operation data, player character data, NPC data, enemy character data, object data, first state data, and second state data. As well as these, various pieces of data are stored in the memory.

The game program is a program for executing the game processing described below. The game program is stored in advance in the external storage medium attached to the slot 23 or the flash memory 84, and when the game is executed, is loaded into the DRAM 85. The game program may be acquired from another apparatus via a network (e.g., the Internet). The operation data is data regarding operations acquired from the left controller 3 and the right controller 4. For example, the operation data includes data relating to operations on the left and right analog sticks and data relating to operations on the buttons. For example, the operation data is transmitted from the left controller 3 and the right controller 4 to the main body apparatus 2 at predetermined time intervals (e.g., 1/200-second intervals) and stored in the memory.

The player character data is data regarding the player character 100 and includes data regarding the position in the virtual space, the direction, the moving direction, the moving velocity, and the like of the player character 100. The player character data also includes the life value of the player character 100. The player character data also includes data regarding the external appearance such as the shape of the player character 100. The player character data also includes owned item data indicating items owned by the player character 100 (weapon objects, a protective gear object, other items used in the game, and the like). The player character data also includes equipment data indicating a weapon object with which the player character 100 is equipped.

The NPC data includes data regarding the above first NPC 110 and data regarding the above second NPC 111. The data regarding the first NPC 110 includes data regarding the position in the virtual space, the direction, the moving direction, the moving velocity, and the like of the first NPC 110. The data regarding the first NPC 110 also includes data indicating the external appearance such as the shape of the first NPC 110 and attribute data. The data regarding the second NPC 111 includes data of the same type as the data regarding the first NPC 110. Further, a third NPC and a fourth NPC may be placed in addition to the first NPC 110 and the second NPC 111 in the virtual space. In this case, the NPC data includes data regarding the third NPC and the fourth NPC. Each of the third NPC and the fourth NPC is associated with a unique effect.

The enemy character data is data regarding the plurality of enemy characters 200 placed in the virtual space. The enemy character data includes data regarding the position in the virtual space, the direction, the moving direction, the moving velocity, and the like of each enemy character 200. The enemy character data also includes the life value of each enemy character 200. The enemy character data also includes data regarding the external appearance such as the shape of each enemy character 200 and data regarding the attribute of each enemy character 200.

The object data is data regarding objects placed in the virtual space (e.g., objects as obstacles to the player character 100, such as the sludge object 301 and the fire object). The object data includes data regarding the position in the virtual space of each object. The object data also includes data regarding the external appearance such as the shape of each object and data regarding the attribute of each object.

The first state data is data indicating whether or not the player character 100 is in the above implementable state.

The second state data is data indicating whether or not the second effect associated with the second NPC 111 is produced.

(Details of Game Processing Performed by Main Body Apparatus 2)

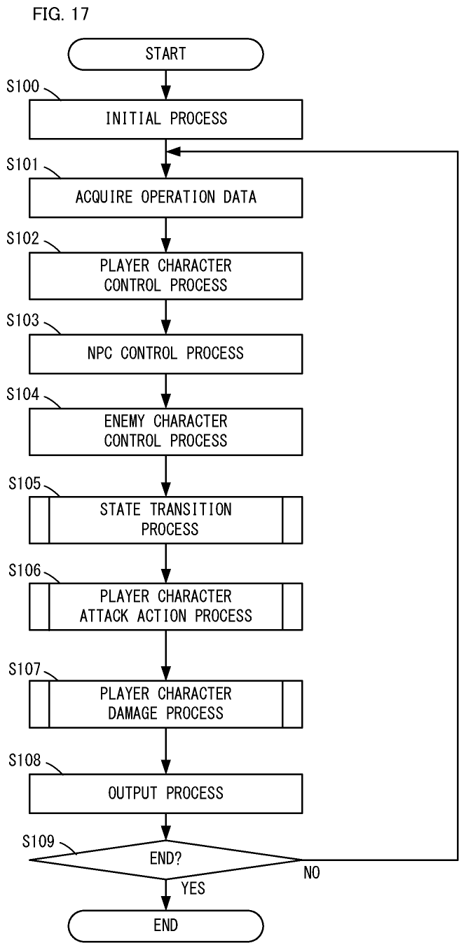

Next, the details of game processing performed by the main body apparatus 2 are described. FIG. 17 is a flow chart showing an example of game processing executed by the processor 81 of the main body apparatus 2.

As shown in FIG. 17, first, the processor 81 executes an initial process (step S100). Specifically, the processor 81 sets the three-dimensional virtual space and places the player character 100, the enemy characters 200, the first NPC 110, the second NPC 111, a virtual camera, and other objects in the virtual space. After executing the initial process, the processor 81 repeatedly executes the processes of subsequent steps S101 to S109 at predetermined frame time intervals (e.g., 1/60-second intervals).

In step S101, the processor 81 acquires operation data from the controllers. The operation data includes data regarding the operation states of the buttons and the analog sticks of the left controller 3, the buttons and the analog sticks of the right controller 4, and the like. In step S101, the processor 81 acquires the operation data transmitted from the controllers and stored in the memory.

Next, the processor 81 performs a player character control process (step S102). Here, the process of moving the player character 100 in the virtual space based on the operation data is performed. For example, the processor 81 moves the player character 100 in a direction in the virtual space relating to the input direction of the left analog stick 32 by an amount of movement relating to a single frame. During a plurality of frames from the start of an attack action in a player character attack action process described below, in step S102, the processor 81 advances the animation of the attack action by a single frame. The process of step S102 is repeatedly performed at the predetermined frame time intervals, whereby the animation of the player character 100 moving in the virtual space and the animation of the player character performing an attack action are displayed.

Next, the processor 81 performs an NPC control process (step S103). Here, the processor 81 moves the first NPC 110 and the second NPC 111 in the virtual space in accordance with a predetermined algorithm and causes the first NPC 110 and the second NPC 111 to perform predetermined actions in the virtual space. For example, the processor 81 automatically controls the position of the first NPC 110 so that the first NPC 110 follows the player character 100. If the player character 100 stops, the processor 81 stops the first NPC 110. The processor 81 also causes the first NPC 110 to perform an action. For example, the processor 81 controls the first NPC 110 to fight with an enemy character 200 as the action. Similarly, the processor 81 controls the movement and the action of the second NPC 111. Based on these types of control, the processor 81 moves the NPCs by amounts of movement relating to a single frame and advances the animations of the NPCs based on the actions by a single frame.

Next, the processor 81 performs an enemy character control process (step S104). Specifically, the processor 81 moves the enemy characters 200 in the virtual space in accordance with a predetermined algorithm and causes the enemy characters 200 to appear in the virtual space. In accordance with a predetermined algorithm, the processor 81 also causes each enemy character 200 to perform an attack action on the player character 100.

Next, the processor 81 performs a state transition process (step S105). Here, based on the operation data, the processor 81 causes the player character 100 to transition to the above implementable state. The details of the state transition process in step S105 will be described below.

Next, the processor 81 performs a player character attack action process (step S106). Here, based on the operation data, the processor 81 equips the player character 100 with a weapon object or causes the player character 100 to perform an attack action using a weapon object. If the player character 100 is in the implementable state, based on the operation data, the processor 81 causes the player character 100 to perform an attack action having the first effect. The details of the player character attack action process will be described below.

Next, the processor 81 performs a player character damage process (step S107). Here, if the player character 100 is attacked, damage is caused on the player character 100. The details of the player character damage process will be described below.

Next, the processor 81 performs an output process (step S108). Specifically, the processor 81 generates an image of the virtual space relating to the results of the processes of the above steps S102 to S107 using the virtual camera and outputs the generated image to a display apparatus. The processor 81 also outputs a sound with the generation and the output of the image. Consequently, a game image is displayed on the display apparatus, and a sound relating to the game processing is output from a speaker.

Next, the processor 81 determines whether or not the game processing is to be ended (step S109). For example, if the player gives an instruction to end the game, the processor 81 determines that the game processing is to be ended (step S109: YES). Then, the processor 81 ends the game processing shown in FIG. 17. If the processor 81 determines that the game processing is not to be ended (step S109: NO), the processor 81 executes the process of step S101 again. This is the description of the game processing shown in FIG. 17.

(State Transition Process)

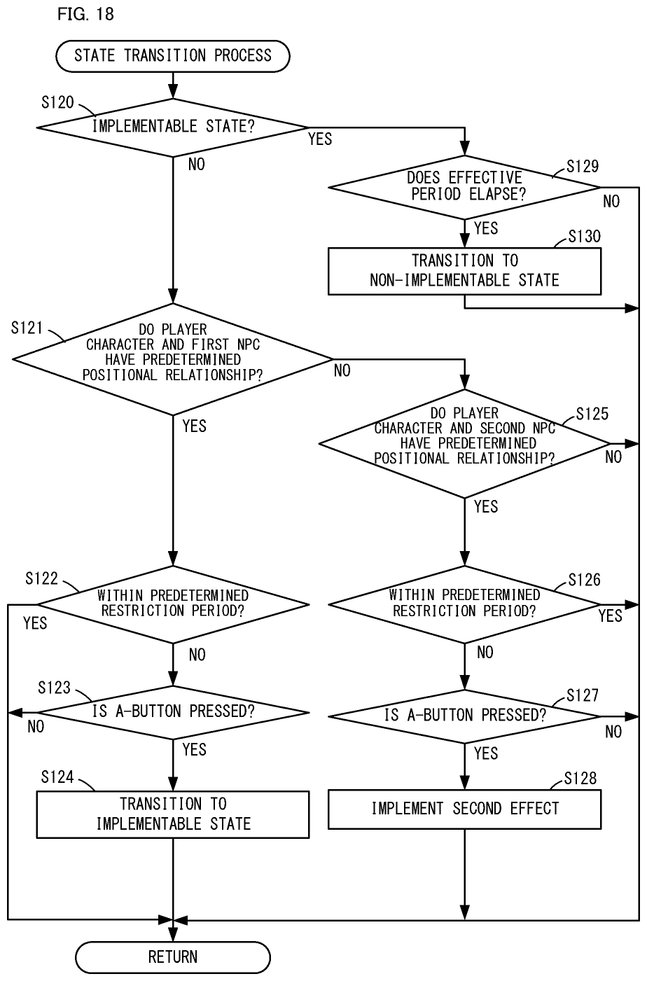

Next, the details of the state transition process in the above step S105 are described. FIG. 18 is a flow chart showing an example of the state transition process in step S105.

In step S120, the processor 81 determines whether or not the player character 100 is currently in the implementable state. Specifically, with reference to the first state data, the processor 81 determines whether or not player character 100 is in the implementable state.

If the player character 100 is not in the implementable state (step S120: NO), the processor 81 determines whether or not the player character 100 and the first NPC 110 have a predetermined positional relationship (step S121). For example, the processor 81 determines whether or not the distance between the player character 100 and the first NPC 110 is less than a predetermined threshold.

If it is determined that the player character 100 and the first NPC 110 have the predetermined positional relationship (step S121: YES), the processor 81 determines whether or not the current time is within a predetermined restriction period (step S122). For example, the predetermined restriction period is set in a case where the water object 105 is discharged, or in a case where the attack of an enemy character 200 is disabled or reduced by the water object 105, or in a case where the player character 100 enters the implementable state. The predetermined restriction period may be the period from when the water object 105 is discharged to when a certain time elapses, or may be the period from when the attack of the enemy character 200 is disabled or reduced by the water object 105 to when a certain time elapses, or may be the period from when the player character 100 transitions to the implementable state to when a certain period elapses.

If it is determined that the current time is within the predetermined restriction period (step S122: YES), the processor 81 ends the state transition process shown in FIG. 18.

If it is determined that the current time is not within the predetermined restriction period (step S122: NO), based on the operation data, the processor 81 determines whether or not the A-button is pressed (step S123). If it is determined that the A-button is pressed (step S123: YES), the processor 81 causes the player character 100 to transition to the implementable state (step S124). Specifically, the processor 81 stores in the first state data a value indicating that the player character 100 is in the implementable state. The processor 81 also places the water object 105 around the player character 100. Consequently, the player character 100 enters the state where the player character 100 wears the water object 105.

If it is determined that the A-button is not pressed (step S123: NO), the processor 81 ends the state transition process shown in FIG. 18.

If, on the other hand, it is determined that the player character 100 and the first NPC 110 do not have the predetermined positional relationship (step S121: NO), the processor 81 determines whether or not the player character 100 and the second NPC 111 have a predetermined positional relationship (step S125). For example, the processor 81 determines whether or not the distance between the player character 100 and the second NPC 111 is less than a predetermined threshold.

If it is determined that the player character 100 and the second NPC 111 have the predetermined positional relationship (step S125: YES), the processor 81 determines whether or not the current time is within a predetermined restriction period (step S126). The predetermined restriction period in step S126 may be set based on the implementation of the second effect associated with the second NPC 111, and the predetermined restriction period may be the period from when the second effect is implemented to when a certain time elapses.

The predetermined restriction period in step S126 and the predetermined restriction period in step S122 may be a common restriction period. For example, after the player character 100 comes close to the first NPC 110 and transitions to the implementable state, and if the player character 100 discharges the water object 105, the player character 100 transitions to the non-implementable state. In this case, a common restriction period is provided, and until the common restriction period elapses, the player character 100 does not transition to the implementable state even if the player character 100 comes close to the first NPC 110. Moreover, a configuration may be employed in which, until the common restriction period elapses, the second effect related to the second NPC 111 is not produced even if the player character 100 comes close to the second NPC 111. That is, if the effect related to one of the NPCs is implemented, a common restriction period is set, and until the common restriction period elapses, not only may the implementation of the effect related to one of the NPCs be restricted, but also the implementation of the effect related to the other NPC may be restricted.

Alternatively, the predetermined restriction period in step S126 and the predetermined restriction period in step S122 may be set separately from each other. For example, after the player character 100 comes close to the first NPC 110 and transitions to the implementable state, and if the water object 105 is discharged, the player character 100 enters the non-implementable state. In this case, a first restriction period related to the first NPC 110 is provided, and until the first restriction period elapses, the player character 100 does not enter the implementable state even if the player character 100 comes close to the first NPC 110. On the other hand, even if the first restriction period does not elapse, the second effect related to the second NPC 111 may be able to be produced by the player character 100 coming close to the second NPC 111. Conversely, if the player character 100 comes close to the second NPC 111 and the second effect related to the second NPC 111 is produced, a second restriction period related to the second NPC 111 is provided, and until the second restriction period elapses, the second effect related to the second NPC 111 cannot be produced even if the player character 100 comes close to the second NPC 111. In this case, even if the second restriction period does not elapse, the player character 100 may come close to the first NPC 110 and enter the implementable state.

If it is determined that the current time is within the predetermined restriction period (step S126: YES), the processor 81 ends the state transition process shown in FIG. 18.

If it is determined that the current time is not within the predetermined restriction period (step S126: NO), based on the operation data, the processor 81 determines whether or not the A-button is pressed (step S127). If it is determined that the A-button is pressed (step S127: YES), the processor 81 implements the second effect associated with the second NPC 111 (step S128). The second effect associated with the second NPC 111 is an effect different from the above first effect. For example, the second effect associated with the second NPC 111 may be the effect of making a special attack in a case where the player character 100 makes a predetermined attack, or may be the expansion of a predetermined area.

If the process of step S124 or S128 is executed, the processor 81 ends the state transition process shown in FIG. 18.

If, on the other hand, it is determined that the player character 100 is in the implementable state (step S120: YES), the processor 81 determines whether or not a predetermined effective period (e.g., 10 seconds) elapses after the player character 100 enters the implementable state (step S129).

If it is determined that the predetermined effective period elapses after the player character 100 enters the implementable state (step S129: YES), the processor 81 causes the player character 100 to transition to the non-implementable state (step S130). That is, the player character 100 is caused to transition to the normal state where the player character 100 cannot implement an attack action having the first effect. Specifically, the processor 81 stores in the first state data a value indicating that the player character 100 is in the normal state. The processor 81 also erases the water object 105 placed around the player character 100. Consequently, the player character 100 returns to the normal state.

If the process of step S130 is performed, or if the determination is NO in step S129, the processor 81 ends the state transition process shown in FIG. 18.

(Player Character Attack Action Process)

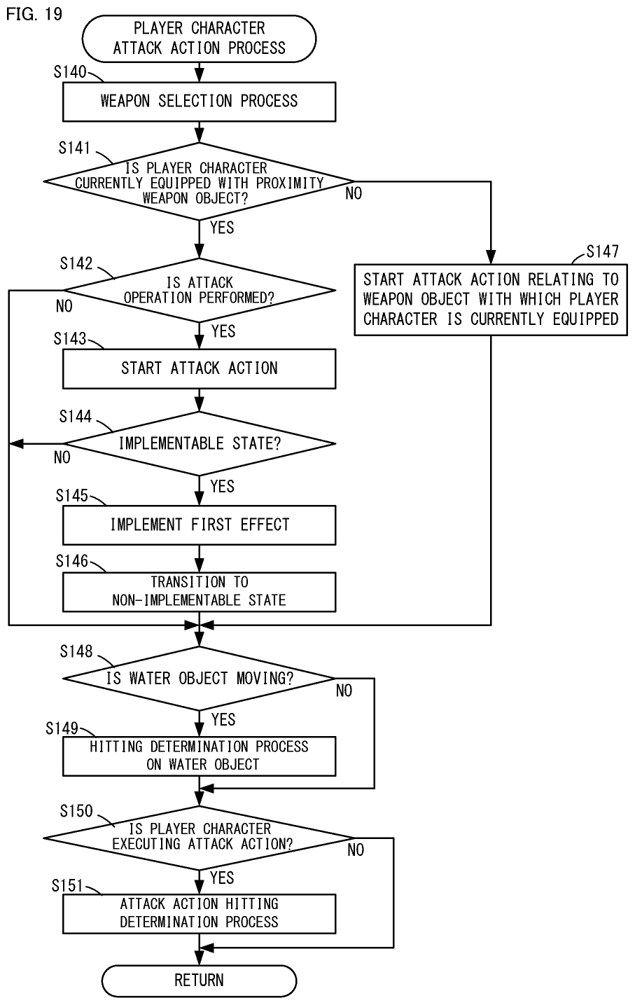

Next, the details of the player character attack action process in the above step S106 are described. FIG. 19 is a flow chart showing an example of the player character attack action process in step S106.

In step S140, first, the processor 81 performs a weapon selection process. Here, based on the operation data, the processor 81 determines whether or not a weapon selection operation is performed by the player. If it is determined that a weapon selection operation is performed by the player, based on the operation data, the processor 81 selects a weapon object with which the player character 100 is equipped, and stores data indicating the selected weapon object as the equipment data. Consequently, the player character 100 is equipped with any of the plurality of weapon objects owned by the player character 100.

Next, the processor 81 determines whether or not the player character 100 is currently equipped with a proximity weapon object (step S141). Specifically, with reference to the equipment data, the processor 81 determines whether or not the weapon object with which the player character 100 is equipped is a proximity weapon object.

If it is determined that the player character 100 is currently equipped with a proximity weapon object (step S141: YES), based on the operation data, the processor 81 determines whether or not an attack operation is performed (step S142). For example, based on the operation data, the processor 81 determines whether or not the Y-button is pressed.

If it is determined that an attack operation is performed (step S142: YES), the processor 81 causes the player character 100 to start an attack action using the weapon object with which the player character 100 is currently equipped (step S143). Consequently, for example, if the player character 100 is equipped with the sword object 101, the attack action of the player character 100 swinging the sword object 101 is started. During a plurality of frames from the start of the attack action, the animation of the player character 100 regarding the attack action is displayed.

If the process of step S143 is performed, the processor 81 determines whether or not the player character 100 is in the implementable state (step S144). Specifically, with reference to the first state data, the processor 81 determines whether or not the player character 100 is in the implementable state (i.e., the state where the player character 100 wears the water object 105).

If it is determined that the player character 100 is in the implementable state (step S144: YES), the processor 81 implements the first effect (step S145). Specifically, the processor 81 discharges the water object 105 in the front direction of the player character 100. Consequently, the water object 105 starts moving in the virtual space. The processor 81 sets the shape, the size (the width), the moving velocity, and the flying distance of the water object 105 in accordance with the type of the weapon object with which the player character 100 is currently equipped.

Next, the processor 81 causes the player character 100 to transition to the non-implementable state (step S146). Specifically, the processor 81 stores in the first state data a value indicating that the player character 100 cannot implement the first effect. Consequently, the player character 100 returns to the normal state where the player character 100 does not wear the water object 105.

If, on the other hand, it is determined that the player character 100 is not currently equipped with a proximity weapon object (step S141: NO), based on the operation data, the processor 81 causes the player character 100 to start an attack action relating to the weapon object with which the player character 100 is currently equipped (step S147). Here, based on the operation data, the processor 81 determines whether or not an operation input for an attack action is provided, and also causes the player character 100 to start the attack action using the weapon object with which the player character 100 is currently equipped. During a plurality of frames from the start of the attack action, the animation of the player character 100 regarding the attack action is displayed. For example, if the player character 100 is currently equipped with the bow-and-arrow object, based on the operation data, the processor 81 determines whether or not the ZR-button is pressed. If the player character 100 is currently equipped with the bow-and-arrow object and the ZR-button is pressed, the processor 81 causes the player character 100 to start the action of flying the arrow object and discharges the arrow object to the virtual space.

If the determination is NO in step S142, or if the determination is NO in step S144, or if the process of step S146 is executed, or if the process of step S147 is executed, the processor 81 determines whether or not the water object 105 is moving in the virtual space (step S148). Here, it is determined whether or not the water object 105 is discharged in step S145 and the discharged water object 105 is moving in the virtual space.

If it is determined that the water object 105 is moving in the virtual space (step S148: YES), based on the moving velocity of the water object 105, the processor 81 moves the water object 105 by an amount of movement relating to a single frame and also performs a hitting determination process on the water object 105 based on the position of the water object 105 after the movement (step S149). Specifically, the processor 81 determines whether or not the water object 105 hits an object in the virtual space (the enemy characters 200, the sludge object 301, the fire object, and other objects). For example, if the water object 105 hits an enemy character 200, the processor 81 causes damage relating to the offensive strength set for the weapon object used to discharge the water object 105 on the enemy character 200. Consequently, the life value of the enemy character 200 is decreased, and if the life value of the enemy character 200 reaches zero, the enemy character 200 falls over. If the water object 105 hits the sludge object 301, the processor 81 removes the sludge object 301. If the water object 105 hits the fire object, the processor 81 removes the fire object.

If the determination is NO in step S148, or if step S149 is executed, the processor 81 determines whether or not the player character 100 is executing an attack action (step S150). Here, it is determined whether or not the player character 100 starts an attack action in step S143 or S147 and is executing the attack action. For example, if the player character 100 is swinging the sword object 101, the determination of the processor 81 is YES in step S150. If the player character 100 is swinging the sword object 102, the determination is YES in step S150. If the player character 100 is executing the attack action using the spear object, the determination of the processor 81 is YES in step S150. If the player character 100 discharges the arrow object in step S147 and the discharged arrow object is moving in the virtual space, the determination of the processor 81 is YES in step S150.

If it is determined that the player character 100 is executing an attack action (step S150: YES), the processor 81 performs an attack action hitting determination process (step S151). Here, it is determined whether or not the attack action of the player character 100 hits an enemy character 200 or another object in the virtual space, and a process in a case where the player character 100 hits an enemy character 200 or another object is performed. For example, if the player character 100 is executing the attack action of swinging the sword object 101, the processor 81 determines whether or not the sword object 101 hits an enemy character 200. If the sword object 101 hits an enemy character 200, the processor 81 causes damage relating to the offensive strength of the sword object 101 on the enemy character 200. Consequently, the life value of the enemy character 200 is decreased, and if the life value of the enemy character 200 reaches zero, the enemy character 200 falls over. If the player character 100 is executing the attack action of swinging the sword object 102, the processor 81 determines whether or not the sword object 102 hits an enemy character 200. If the sword object 102 hits an enemy character 200, the processor 81 causes damage relating to the offensive strength of the sword object 102 on the enemy character 200. If the arrow object is moving in the virtual space, based on the moving velocity of the arrow object, the processor 81 moves the arrow object by an amount of movement relating to a single frame, and based on the position of the arrow object after the movement, also determines whether or not the arrow object hits an enemy character 200. If the arrow object hits an enemy character 200, the processor 81 causes damage relating to the offensive strength of the arrow object on the enemy character 200. For example, in a case where the player character 100 is executing the attack action of swinging the sword object 101, and if the sword object 101 hits a tree object in the virtual space, the tree object may be destroyed or cut.

If the determination is NO in step S150, or if step S151 is executed, the processor 81 ends the player character attack action process shown in FIG. 19.

(Player Character Damage Process)

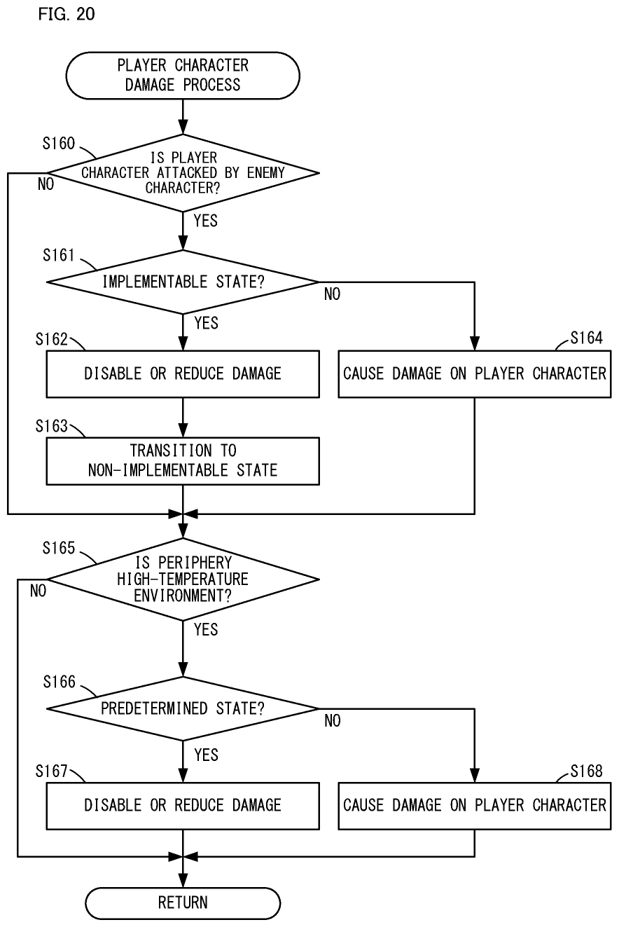

Next, the details of the player character damage process in the above step S107 are described. FIG. 20 is a flow chart showing an example of the player character damage process in step S107.

In step S160, the processor 81 determines whether or not the player character 100 is attacked by an enemy character 200. Here, based on the positional relationship between the player character 100 and an enemy character 200 or the attack action of the enemy character 200, it is determined whether or not the attack action of the enemy character 200 hits the player character 100.

If it is determined that the player character 100 is attacked by an enemy character 200 (step S160: YES), the processor 81 determines whether or not the player character 100 is in the implementable state (step S161).

If it is determined that the player character 100 is in the implementable state (step S161: YES), the processor 81 disables or reduces the attack of the enemy character 200 (step S162), and causes the player character 100 to transition to the non-implementable state (step S163). That is, in response to the attack of the enemy character 200, damage is not caused on the player character 100 (or damage on the player character 100 is reduced), and the player character 100 is caused to transition to the normal state. Specifically, the processor 81 stores in the first state data a value indicating that the player character 100 is in the normal state. The processor 81 also erases the water object 105. Consequently, the player character 100 returns to the normal state where the player character 100 does not wear the water object 105. If it is determined that the player character 100 is not in the implementable state (step S161: NO), the processor 81 causes damage on the player character 100 (step S164). Here, damage having an amount relating to the type of the enemy character 200 or the type of the attack action may be caused on the player character 100. The damage is caused on the player character 100, whereby the life value of the player character 100 decreases.

If the determination is NO in step S160, or if step S163 is executed, or if step S164 is executed, the processor 81 determines whether or not the periphery of the player character 100 is a high-temperature environment (step S165).

If it is determined that the periphery is a high-temperature environment (step S165: YES), the processor 81 determines whether or not the player character 100 is in a predetermined state (step S166). Here, it is determined whether or not the player character 100 is in the state where the player character 100 is wet. If the player character 100 is in the implementable state, the determination of the processor 81 is YES in step S166. For example, if the player character 100 is under water, the determination of the processor 81 is YES in step S166.

If it is determined that the player character 100 is in the predetermined state (step S166: YES), the processor 81 disables or reduces damage due to the high-temperature environment (step S167). That is, damage is not caused (or damage is reduced) on the player character 100 due to the high-temperature environment.

If it is determined that the player character 100 is not in the predetermined state (step S166: NO), the processor 81 causes damage due to the high-temperature environment on the player character 100 (step S168). For example, in accordance with the time in which the player character 100 is in the high-temperature environment, the processor 81 decreases the life value of the player character 100.

If the determination is NO in step S165, or if step S167 is executed, or if step S168 is executed, the processor 81 ends the player character damage process shown in FIG. 20.

(Variations)

While the exemplary embodiment has been described above, the exemplary embodiment is merely an example and may be modified as follows, for example.

For example, in the above exemplary embodiment, the player character 100 performs an attack action using a weapon object in the implementable state, whereby the water object 105 is discharged in addition to the attack action. In another exemplary embodiment, on the premise that the player character 100 performs not only an attack action using a weapon object but also an attack action without using a weapon object, such as a punch or a kick, if the player character 100 performs an attack action in the implementable state, the water object 105 may be discharged with the attack action.

In the above exemplary embodiment, the player character 100 is equipped with any of the plurality of weapon objects owned by the player character 100 in advance and performs an attack action using the weapon object with which the player character 100 is equipped. In another exemplary embodiment, the player character 100 may not own the plurality of weapon objects in advance, and for example, may acquire any of a plurality of weapon objects placed on the ground in the virtual space and perform an attack action using the acquired weapon object. In this case, the shape, the size, the moving velocity, the flying distance, the offensive strength, and the like of the water object 105 to be discharged may differ in accordance with the acquired weapon object.

On the premise that the player character 100 is caused to perform an attack action, if the player character 100 performs the attack action in the implementable state, the water object 105 is discharged (the first effect is implemented) with the attack action. In another exemplary embodiment, on the premise that the player character 100 is caused to perform a predetermined action (e.g., a jump or a dash), if the player character 100 performs the predetermined action in the implementable state, the first effect may be implemented with the predetermined action.

In the above exemplary embodiment, if the player character 100 performs a predetermined action in the implementable state, the predetermined action is performed, and the effect of discharging the water object 105 to the virtual space is also implemented. In another exemplary embodiment, if the player character 100 performs a predetermined action in the implementable state, any other effect may be implemented with the predetermined action. For example, any object other than the water object 105 and related to the first NPC may be discharged to the virtual space. Moreover, not only the effect of discharging an object, but also, for example, a predetermined effect (e.g., the effect of increasing the offensive strength or the defensive strength of the player character 100, the effect of decreasing the offensive strength or the defensive strength of an enemy character 200, the effect of slowing the motion of an enemy character 200, or the like) may be implemented for a predetermined time in the virtual space.

In the above exemplary embodiment, in a case where the player character 100 transitions to the implementable state, and if any of the condition that the above predetermined effective period elapses, the condition that the player character 100 is attacked by an enemy character 200, and the condition that the water object 105 is discharged holds true, the player character 100 transitions from the implementable state to the non-implementable state. In another exemplary embodiment, also in a case other than these conditions, the player character 100 may transition from the implementable state to the non-implementable state. For example, in a case where the player character 100 is in the implementable state, and if the player character 100 is in an environment where the player character 100 becomes damaged in the virtual space (e.g., a high-temperature environment near a lava), the player character 100 may transition to the non-implementable state before the predetermined effective period elapses after the player character 100 transitions to the implementable state. In another exemplary embodiment, the above predetermined effective period may not be provided. In this case, if either of the condition that the player character 100 is attacked by an enemy character 200 in the implementable state, and the condition that the water object 105 is discharged holds true, the player character 100 may transition to the non-implementable state.

In the above exemplary embodiment, in a case where the player character 100 transitions to the implementable state, and if either of the condition that the player character 100 is attacked by an enemy character 200 and the condition that the water object 105 is discharged holds true, the player character 100 is caused to transition to the non-implementable state, and until the predetermined restriction period elapses, the player character 100 is prohibited from transitioning to the implementable state again. After the player character 100 transitions to the implementable state, and also if the player character 100 enters the non-implementable state due to the lapse of the above predetermined effective period, such a restriction period may be provided. In another exemplary embodiment, if the player character 100 transitions from the implementable state to the non-implementable state, such a restriction period may not be provided.

In the above exemplary embodiment, a game that progresses while the player controls the player character 100 to defeat the enemy characters 200 automatically controlled by the processor 81 is assumed. In another exemplary embodiment, for example, a game where players fight with each other while controlling player characters of the players may be performed. In this case, each player character may be able to come close to the above first NPC 110, transition to the implementable state, and implement the first effect with a predetermined action.

The processes shown in the above flow charts are merely illustrative, and the order and the contents of the processes, and the like may be appropriately changed.

The configuration of the hardware that performs the above game is merely an example, and the above game processing may be performed by any other hardware. For example, the above game processing may be executed by any information processing apparatus such as a personal computer, a tablet terminal, a smartphone, or a server on the Internet. The above game processing may also be executed by an information processing apparatus including a plurality of apparatuses.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A non-transitory computer-readable storage medium having stored therein instructions that, when executed, cause a processor to execute game processing comprising:
moving a player character in a virtual space based on a first operation input;
automatically moving a first non-player character in the virtual space;
if the player character and the first non-player character have a predetermined positional relationship, in accordance with a second operation input, causing the player character to transition to an implementable state where the player character can implement a predetermined action having a first effect; and
if the player character is in the implementable state, in accordance with a third operation input, causing the player character to perform the predetermined action having the first effect.

2. The non-transitory computer-readable storage medium according to claim 1, wherein the game processing further comprises:
if the player character is caused to perform the predetermined action having the first effect, causing the player character to transition from the implementable state to a non-implementable state where the player character cannot implement the predetermined action having the first effect.

3. The non-transitory computer-readable storage medium according to claim 2, wherein the game processing further comprises:
controlling an enemy character in the virtual space;
causing the enemy character to perform an attack action;
causing damage on the player character based on the attack action of the enemy character; and
if the player character is in the implementable state, disabling or reducing the damage based on the attack action of the enemy character.

4. The non-transitory computer-readable storage medium according to claim 3, wherein the game processing further comprises:
if the damage is disabled or reduced, causing the player character to transition from the implementable state to the non-implementable state.

5. The non-transitory computer-readable storage medium according to claim 4, wherein the game processing further comprises:
maintaining the player character in the non-implementable state until a predetermined time elapses after the player character transitions from the implementable state to the non-implementable state.

6. The non-transitory computer-readable storage medium according to claim 1, wherein the game processing further comprises:
causing the player character to perform an attack action as the predetermined action based on the third operation input, regardless of whether or not the player character is in the implementable state, and
the first effect is an additional attack effect produced with the attack action.

7. The non-transitory computer-readable storage medium according to claim 6, wherein the game processing further comprises:
equipping the player character with any of a plurality of types of weapon objects,
the attack action is an action of making an attack using the weapon object with which the player character is equipped, and
the additional attack effect has a performance that differs in accordance with the type of the weapon object with which the player character is equipped.

8. The non-transitory computer-readable storage medium according to claim 6, wherein
the attack effect has an effect of removing a predetermined obstacle object in the virtual space.

9. The non-transitory computer-readable storage medium according to claim 1, wherein the game processing further comprises:
automatically moving a second non-player character in the virtual space; and
if the player character and the second non-player character have a predetermined positional relationship, producing a second effect in accordance with the second operation input.

10. The non-transitory computer-readable storage medium according to claim 9, wherein the game processing further comprises:
causing the first non-player character and the second non-player character to automatically battle.

11. An information processing system comprising:
a processor; and
a storage medium storing executable instructions that, when executed, cause the processor to execute game processing comprising:
moving a player character in a virtual space based on a first operation input;
automatically moving a first non-player character in the virtual space;
if the player character and the first non-player character have a predetermined positional relationship, in accordance with a second operation input, causing the player character to transition to an implementable state where the player character can implement a predetermined action having a first effect; and
if the player character is in the implementable state, in accordance with a third operation input, causing the player character to perform the predetermined action having the first effect.

12. The information processing system according to claim 11, wherein the game processing further comprises:
if the player character is caused to perform the predetermined action having the first effect, causing the player character to transition from the implementable state to a non-implementable state where the player character cannot implement the predetermined action having the first effect.

13. The information processing system according to claim 12, wherein the game processing further comprises:
controlling an enemy character in the virtual space;
causing the enemy character to perform an attack action;
causing damage on the player character based on the attack action of the enemy character; and
if the player character is in the implementable state, disabling or reducing the damage based on the attack action of the enemy character.

14. The information processing system according to claim 13, wherein the game processing further comprises:
if the damage is disabled or reduced, causing the player character to transition from the implementable state to the non-implementable state.

15. The information processing system according to claim 14, wherein the game processing further comprises:
maintaining the player character in the non-implementable state until a predetermined time elapses after the player character transitions from the implementable state to the non-implementable state.

16. The information processing system according to claim 11, wherein the game processing further comprises:
causing the player character to perform an attack action as the predetermined action based on the third operation input, regardless of whether or not the player character is in the implementable state, and
the first effect is an additional attack effect produced with the attack action.

17. The information processing system according to claim 16, wherein the game processing further comprises:
equipping the player character with any of a plurality of types of weapon objects,
the attack action is an action of making an attack using the weapon object with which the player character is equipped, and
the additional attack effect has a performance that differs in accordance with the type of the weapon object with which the player character is equipped.

18. The information processing system according to claim 16, wherein
the attack effect has an effect of removing a predetermined obstacle object in the virtual space.

19. The information processing system according to claim 11, wherein the game processing further comprises:
automatically moving a second non-player character in the virtual space; and
if the player character and the second non-player character have a predetermined positional relationship, producing a second effect in accordance with the second operation input.

20. The information processing system according to claim 19, wherein the game processing further comprises:
causing the first non-player character and the second non-player character to automatically battle.

21. An information processing apparatus comprising:
a processor; and
a storage medium storing executable instructions that, when executed, cause the processor to execute game processing comprising:
moving a player character in a virtual space based on a first operation input;
automatically moving a first non-player character in the virtual space;
if the player character and the first non-player character have a predetermined positional relationship, in accordance with a second operation input, causing the player character to transition to an implementable state where the player character can implement a predetermined action having a first effect; and
if the player character is in the implementable state, in accordance with a third operation input, causing the player character to perform the predetermined action having the first effect.

22. The information processing apparatus according to claim 21, wherein the game processing further comprises:
if the player character is caused to perform the predetermined action having the first effect, causing the player character to transition from the implementable state to a non-implementable state where the player character cannot implement the predetermined action having the first effect.

23. The information processing apparatus according to claim 22, wherein the game processing further comprises:
controlling an enemy character in the virtual space;
causing the enemy character to perform an attack action;
causing damage on the player character based on the attack action of the enemy character; and
if the player character is in the implementable state, disabling or reducing the damage based on the attack action of the enemy character.

24. An information processing method performed by an information processing system, the information processing method comprising:
moving a player character in a virtual space based on a first operation input;
automatically moving a first non-player character in the virtual space;
if the player character and the first non-player character have a predetermined positional relationship, in accordance with a second operation input, causing the player character to transition to an implementable state where the player character can implement a predetermined action having a first effect; and
if the player character is in the implementable state, in accordance with a third operation input, causing the player character to perform the predetermined action having the first effect.

25. The information processing method according to claim 24, further comprising, if the player character is caused to perform the predetermined action having the first effect, causing the player character to transition from the implementable state to a non-implementable state where the player character cannot implement the predetermined action having the first effect.

26. The information processing method according to claim 25, further comprising:
controlling an enemy character in the virtual space;
causing the enemy character to perform an attack action;
causing damage on the player character based on the attack action of the enemy character; and
if the player character is in the implementable state, disabling or reducing the damage based on the attack action of the enemy character.
